(19) United States
(12) Patent Application Publication
(10) Pub. No.: US 2012/0142277 A1
(43) Pub. Date: Jun. 7, 2012

(54) INTELLIGENT COUPLER

(76) Inventors: Paul J. Vermette, Milford, NH (US); Robert R. Burns, Milford, NH (US)

(21) Appl. No.: 13/304,994

(22) Filed: Nov. 28, 2011

Related U.S. Application Data
(60) Provisional application No. 61/418,709, filed on Dec. 1, 2010.

(51) Int. Cl. H04B 17/00

(52) U.S. Cl. 455/67.14

(57) ABSTRACT

In accordance with an embodiment of the invention, there is provided an antenna coupler for providing a radio frequency interface between a radio frequency electronic system of a unit under test and automatic test equipment for the radio frequency electronic system. The antenna coupler comprises a mechanical interface to secure the antenna coupler to an antenna site of the unit under test, and a radio frequency signature storage component comprising a stored representation of a radio frequency signature comprising radio frequency test output.

### RELATED APPLICATION

This application claims the benefit of U.S. Provisional Application No. 61/418,709, filed on Dec. 1, 2010. The entire teachings of the above application are incorporated herein by reference.

### BACKGROUND OF THE INVENTION

Antenna couplers are an integral element of test systems used to perform “end to end” tests of radio frequency (RF) systems, which may be embedded in various weapons platforms. The test system includes a test set, a test program set (typically implemented in software) and several antenna coupler types.

The antenna couplers are RF interface devices that capture and transfer transmitted RF signals from the test set to the embedded RF system (receiver), and/or receive and transfer the transmitted signals from the RF transmitter embedded in the weapons platform to the test set. The antenna couplers are essential in the performance of end to end testing of embedded RF systems. Testing is performed external to the weapons platform, without breaking into the RF system.

Numerous different antenna coupler types have previously been deployed. An antenna coupler type is uniquely tailored to interface mechanically and electrically with one of the several RF system antenna installation locations on the weapons platform. Antenna couplers have a universal interface that connects to any RF test set including various militarized test sets such as AN/USM-406, AN/USN-670, AN/USM-642 and several commercially configured test sets. Such antenna couplers are produced, for example, by Tech Resources, Inc., of Milford, N.H., U.S.A.

One of the unique challenges associated with antenna coupler design is the fact that antenna coupler antennas and RF system antennas are in close proximity (in the “RF near field”) with each other. Several devices and procedures have previously been used to alter and modify the RF insertion loss characteristics to achieve an accurate and repeatable performance of individual antenna coupler types. Such combinations of RF design features and techniques have been employed to establish and maintain repeatable insertion loss characteristics of various antenna coupler types. Such features and techniques have included: 1) the selection of the antenna type and the antenna location in the antenna coupler; 2) the selection of various RF absorber types and the selection of the absorber location in the antenna coupler; 3) the installation and selection of various RF focusing devices including, for example, a “near field filter”; and 4) many other modifications to achieve a precise and repeatable insertion loss of the antenna couple.

An additional feature of antenna couplers is the requirement to perform an insertion loss self test to ensure the proper performance of the antenna coupler. The eventual design of the antenna coupler must balance the best RF insertion loss characteristics between the RF system insertion loss test characteristics and the antenna coupler self test insertion loss characteristics.

The total RF insertion loss tolerance of the test system is the result of the following design variables: 1) the antenna coupler unit-to-unit tolerance, which is the sum of antenna coupler component tolerances and manufacturing process tolerances; 2) the weapons platform antenna site manufacturing mechanical location tolerances; 3) the sum of the RF component tolerances of the RF system's transmission line; and 4) the test set accuracy, which is the sum of the test set output signal tolerance and input signal tolerance.

The antenna coupler design challenge is to minimize the unit-to-unit tolerance of the antenna coupler. The historical unit-to-unit insertion loss tolerance for various antenna couplers has ranged from +/−2.5 dB to +/−5 dB across broad band frequency ranges (several octaves).

Antenna couplers may be used to test the radio frequency electronic systems embedded in various weapons platforms (or units under test (“UUT's”)), such as aircraft, pods and drones, ships (including surface and underwater ships) and ground platforms of all types. Some of the most sophisticated RF systems with which antenna couplers are used are the various Electronic Warfare (EW) systems installed in aircraft. The coupler is used as an interface between the aircraft and the test set, and provides a radio-frequency output. Typically, an antenna coupler includes: radio-frequency components that are selected to function on the same frequency range as the EW system and aircraft antennas; radio-frequency absorbing material to absorb undesirable radio-frequency energy; and a mechanical attachment to secure the antenna coupler to the aircraft and to provide a tight seal to reduce electromagnetic interference and emissions.

Due to the wide range of frequencies over which antenna couplers operate, there is an ongoing need for reliable techniques for producing and testing antenna couplers so that their performance is within specifications over the range of operating frequencies.

### SUMMARY OF THE INVENTION

In accordance with an embodiment of the invention, there is provided an antenna coupler for providing a radio frequency interface between a radio frequency electronic system of a unit under test and automatic test equipment for the radio frequency electronic system. The antenna coupler comprises a mechanical interface to secure the antenna coupler to an antenna site of the unit under test, and a radio frequency signature storage component comprising a stored representation of a radio frequency signature comprising radio frequency test output.

In further, related embodiments, the antenna coupler may further comprise radio frequency absorbing material configured to absorb radio frequency energy and reduce undesirable spurious radio frequency energy emitted from the radio frequency electronic system of the unit under test, and may further comprise an antenna probe configured to emit radio frequency energy over a frequency range of the antenna site of the unit under test. The radio frequency test output may comprise baseline confidence test output unique to the antenna coupler. The radio frequency signature storage component may comprise a computer-readable medium, which may comprise non-volatile memory comprising at least one of: a non-volatile random access memory (RAM) and a read-only memory (ROM). Further, the radio frequency signature storage component may comprise a two-dimensional barcode and/or a radio-frequency identification (RFID) component. The antenna coupler may further comprise an electronic port configured to permit electronic transfer of the stored representation of the radio frequency signature from the antenna coupler.

In further related embodiments, the stored representation of the radio frequency signature may further comprise logistics output data unique to the antenna coupler, which may comprise history of repairs and/or retuning of the antenna coupler, suggested time-frame for retuning and/or re-characterizing the antenna coupler, history of radio frequency test outputs unique to the antenna coupler, date of testing, unit under test type, degradation of a radio frequency system of the unit under test, serial number of a radar warning used by the unit under test, and serial number of a jammer used by the unit under test. The radio frequency test output may comprise desired radio frequency output for the unit under test, and may comprise radio frequency output unique to the unit under test, including radio frequency output unique to the antenna site of the unit under test. The antenna coupler may comprise a port configured to download output from an electronic port of the unit under test to the radio frequency signature storage component of the antenna coupler. The electronic port of the unit under test may comprise an avionics data bus port of the unit under test. The unit under test may comprise at least one of: an aircraft, a pod, a drone, a surface ship, an underwater ship and a ground platform; and may comprise a weapons platform. The unit under test may comprise an aircraft and the radio frequency electronic system may comprise an electronic countermeasures system of the aircraft.

In another embodiment according to the invention, there is provided a method of testing an antenna coupler, the antenna coupler being configured to test a radio frequency electronic system of a unit under test. The method comprises uploading to a test set a radio frequency signature from a radio frequency signature storage component of the antenna coupler, the radio frequency signature comprising radio frequency test output comprising baseline confidence test output unique to the antenna coupler; emitting through a radio frequency test probe a radio frequency test input to the antenna coupler, thereby inducing radio frequency test output to be detected by a radio frequency confidence test device coupled to the antenna coupler; and comparing the radio frequency output from the radio frequency confidence test device with the uploaded radio frequency signature to assess performance of the antenna coupler relative to the baseline confidence test output unique to the antenna coupler.

In further, related embodiments, the method may comprise rejecting the antenna coupler performance if performance varies by more than a pre-specified amount from the baseline confidence test output unique to the antenna coupler. The pre-specified amount may comprise a limit that is plus or minus approximately 1 dB or less from the baseline confidence test output. The limit may be plus or minus approximately ½ dB from the baseline confidence test output. Uploading the radio frequency signature may be performed during production testing of the antenna coupler and/or during testing of the antenna coupler subsequent to deployment of the antenna coupler.

In another embodiment according to the invention, there is provided a method of testing a radio frequency electronic system of a unit under test. The method comprises uploading to a test set a radio frequency signature from a radio frequency signature storage component of the antenna coupler, the radio frequency signature comprising radio frequency test output; emitting through a probe of the antenna coupler a radio frequency test input to an antenna site of the unit under test, thereby inducing the production of radio frequency test output to be detected by the antenna coupler; and comparing the radio frequency output detected by the antenna coupler with the radio frequency signature to assess performance of the radio frequency electronic system of the unit under test.

In further, related embodiments, uploading the radio frequency signature may comprise uploading a desired radio frequency output for the unit under test, and may comprise uploading radio frequency output unique to the unit under test, such as radio frequency output unique to the antenna site of the unit under test. The method may comprise rejecting the radio frequency electronic system performance if performance varies by more than a pre-specified amount from the radio frequency output unique to the unit under test. The pre-specified amount may comprise a limit that is plus or minus approximately 1 dB or less from the radio frequency output unique to the unit under test. The limit may be plus or minus approximately ½ dB from the radio frequency output unique to the unit under test.

In another embodiment according to the invention, there is provided a method for maintaining test data for an antenna coupler, the antenna coupler being configured to test a radio frequency electronic system of a unit under test. The method comprises emitting through a radio frequency test probe a radio frequency test input to the antenna coupler, thereby inducing radio frequency test output to be detected by a radio frequency confidence test device coupled to the antenna coupler; and storing, in a radio frequency signature storage component of the antenna coupler, a radio frequency signature comprising the radio frequency test output detected by the radio frequency confidence test device.

In another embodiment according to the invention, there is provided a method for maintaining test data for a radio frequency electronic system of a unit under test. The method comprises emitting through a probe of an antenna coupler a radio frequency test input to an antenna site of the unit under test, thereby inducing the production of radio frequency test output to be detected by the antenna coupler; and storing, in a radio frequency signature storage component of the antenna coupler, a radio frequency signature comprising the radio frequency test output detected by the antenna coupler.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a diagram of a typical test set-up for a confidence test of an antenna coupler, in accordance with the prior art.

FIG. 2 is a graph of radio-frequency test output from an antenna coupler, in accordance with the prior art.

FIG. 3 is a graph of a family of radio-frequency test output results, in accordance with the prior art.

FIG. 4 is a graph of a family of couplers showing limit lines 405, in accordance with the prior art.

FIGS. 5A and 5B are graphs showing the assessment of individual couplers relative to previously established limit lines, in accordance with the prior art.

FIG. 6 is a diagram illustrating performance of a confidence test of an antenna coupler in accordance with an embodiment of the invention.

FIG. 7 is a graph of radio frequency confidence test output for an antenna coupler in accordance with an embodiment of the invention.

FIG. 8 is a diagram of an antenna coupler in accordance with an embodiment of the invention.

### DETAILED DESCRIPTION OF THE INVENTION

A description of example embodiments of the invention follows.

An embodiment according to the invention improves the radio frequency insertion loss performance of antenna couplers, for example to as little as +/−½ dB across broad band frequency ranges (several octaves), thus significantly improving the insertion loss tolerance in RF systems and antenna coupler self tests.

Presently, antenna couplers are generally used to perform two types of tests: a confidence test, which is a self-check of the antenna coupler to ensure that the antenna coupler and associated hardware are functioning correctly, and an RF coupling test, which is a test conducted on the unit under test to ensure that the unit under test's radio frequency systems are functioning correctly. Both types of tests, as presently performed, share some common features. Although embodiments are described herein with reference to the testing of electronic warfare systems installed in aircraft, it should be appreciated that embodiments may be used with electronic warfare systems and other radio frequency electronic systems embedded in various units under test, including aircraft, pods and drones, ships (including surface and underwater ships) and ground platforms of all types.

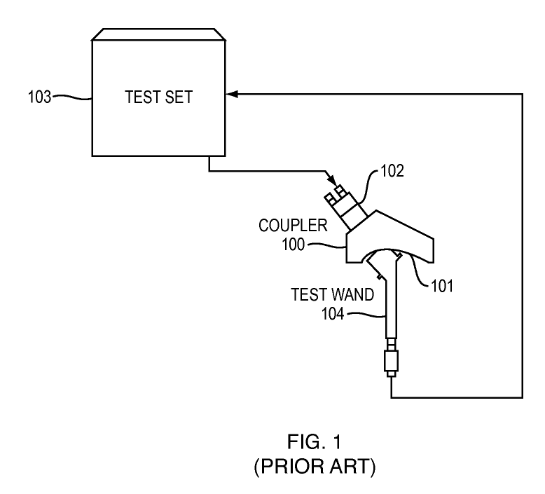

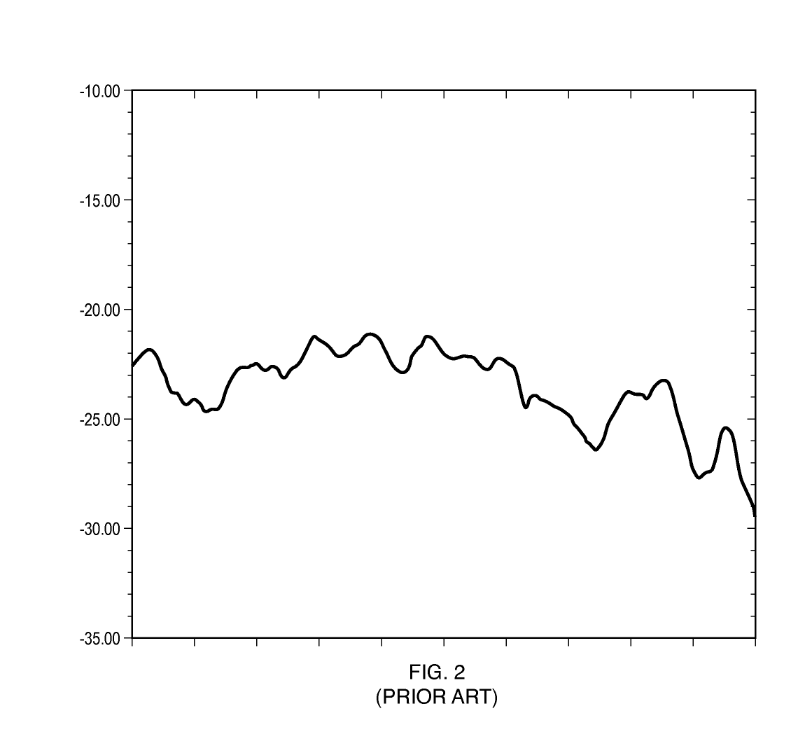

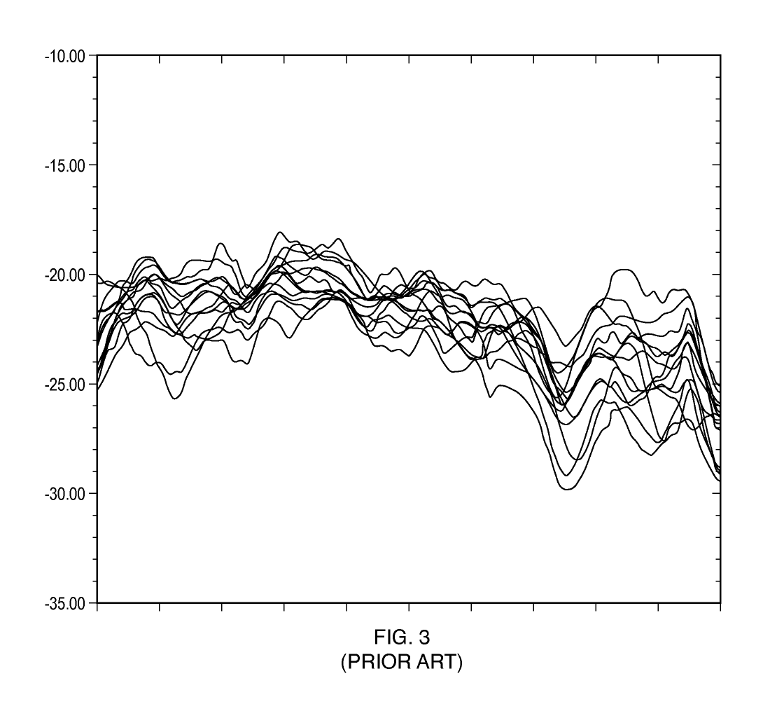

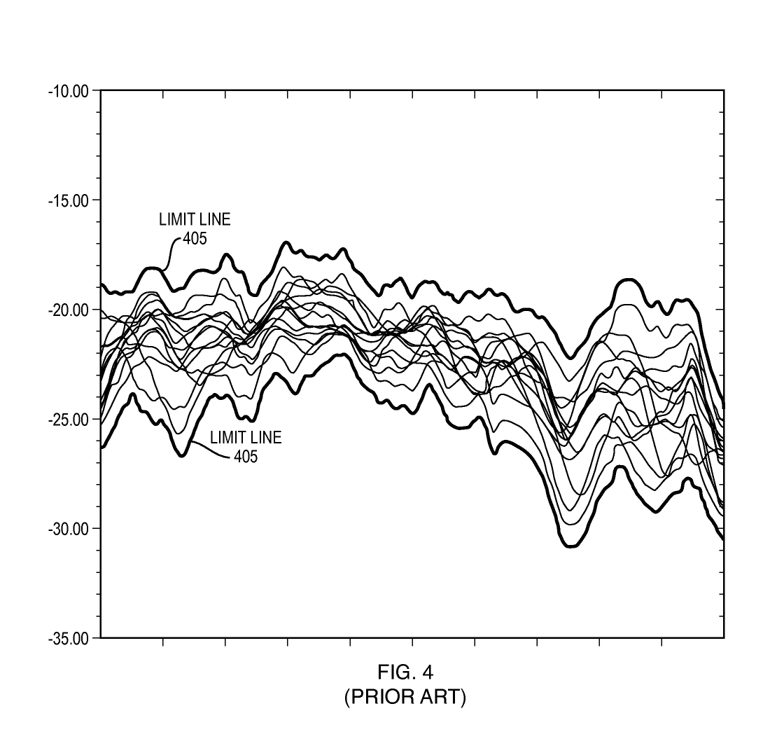

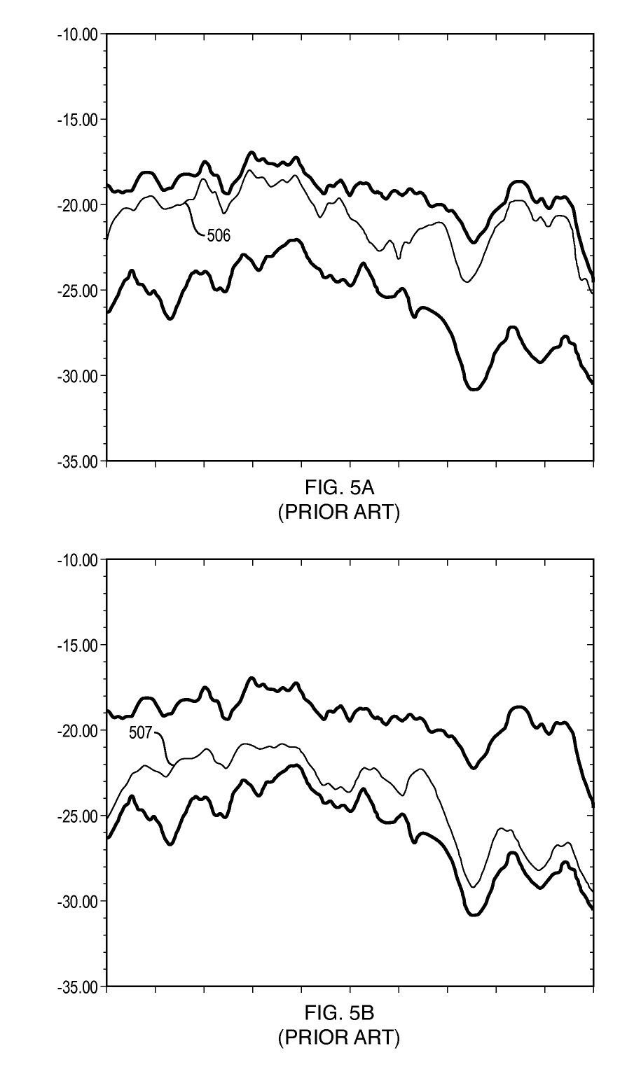

FIG. 1 is a diagram of a typical test set-up for a confidence test of an antenna coupler, in accordance with the prior art. The antenna coupler 100 includes a mechanical interface 101, which is used to secure the antenna coupler 100 to an aircraft during use of the antenna coupler 100, and a probe 102, which provides a radio-frequency output from the antenna coupler 100. In a confidence test of the antenna coupler 100, test data from a test set 103 is fed into the probe 102 and used as the basis for radio-frequency output produced by the antenna coupler 100 that is received by a radio frequency confidence test device, such as a test wand 104. The test wand 104 transmits the radio frequency test output that it receives from the antenna coupler, back to the test set 103. The results of the radio frequency test output are analyzed. FIG. 2 is a graph of radio-frequency test output from an antenna coupler, in accordance with the prior art. The graph shows frequencies on the horizontal axis, in Hz, and intensity of test output measured by the test wand on the vertical axis, in dB. In accordance with the prior art, in order to obtain a statistical sense of the performance of a group of antenna couplers, many such measurements are made on multiple antenna couplers and the many test results are grouped together into a “family” of test output results. FIG. 3 is a graph of a family of radio-frequency test output results, in accordance with the prior art. Based on the results from the group of couplers, limit lines are created, which represent outer bounds on the acceptable performance for future antenna couplers. FIG. 4 is a graph of a family of couplers showing limit lines 405, in accordance with the prior art. These limit lines are stored with the test program and used as accept/reject criteria for future testing of similar antenna couplers. An individual antenna coupler's performance is then assessed using the established acceptance criteria. For example, FIGS. 5A and 5B are graphs showing the assessment of individual couplers relative to previously established limit lines, in accordance with the prior art. The coupler performance 506 in FIG. 5A shows that the individual antenna coupler being tested in that graph would have to degrade significantly before the confidence test fails, whereas the coupler performance 507 in FIG. 5B shows that the individual antenna coupler being tested in that graph need only degrade slightly before the confidence test fails.

In accordance with such prior art techniques, extensive efforts needed to be made in order to ensure that antenna couplers fit within the limit lines, for example by carefully sorting through probes received from manufacturers in order to keep tolerances within desired ranges. Limit lines with a width of about 5 dB were typical, due to the variability between antenna couplers, which placed an upper limit on the consistency of the antenna coupler's performance when used by an end user.

An embodiment according to the invention remedies such drawbacks of the prior art by creating an antenna coupler with unique baseline information stored in the antenna coupler itself, which can be used to closely monitor the coupler's performance and create very tight performance limits for an individual coupler. A baseline confidence test is performed at the site of manufacture of the antenna coupler, such as by an original equipment manufacturer (OEM), and the individual antenna coupler's radio frequency signature (its “fingerprint”) is stored with the coupler.

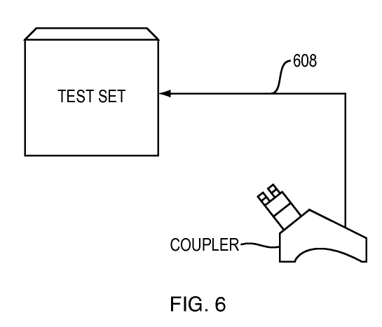

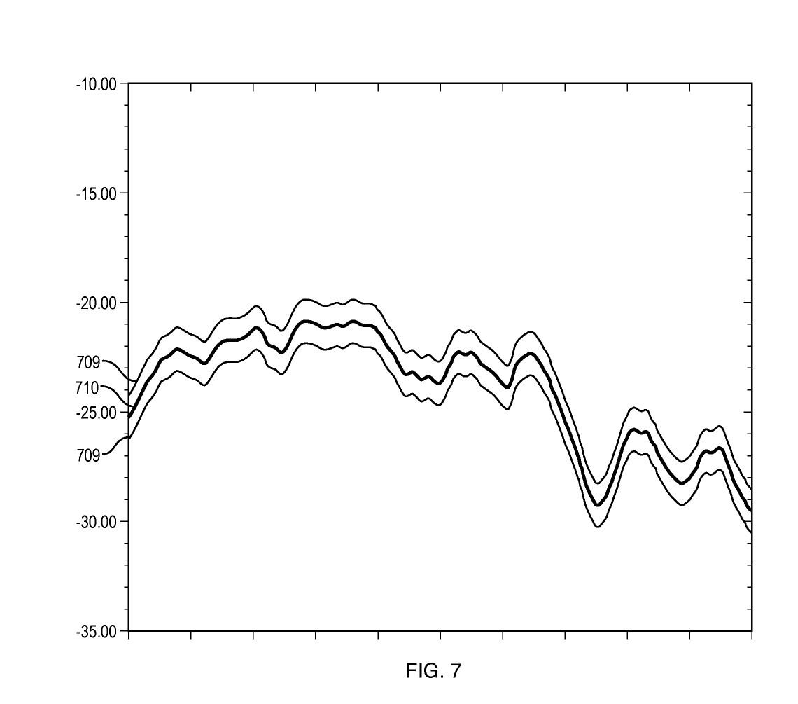

FIG. 6 is a diagram illustrating performance of a confidence test of an antenna coupler in accordance with an embodiment of the invention. Prior to testing, the antenna coupler's fingerprint is uploaded to the test set, for example over a data cable 608. The test set program is then able to create accept/reject criteria unique to the OEM-baselined coupler fingerprint. The coupler is rejected if its performance varies by more than a pre-specified amount from the original baseline performance. FIG. 7 is a graph of radio frequency confidence test output for an antenna coupler in accordance with an embodiment of the invention. Limit lines 709 represent pre-specified amounts by which the antenna coupler's performance is permitted to vary from the original baseline performance 710. Because the limit lines 709 may be based on the performance of a unique individual antenna coupler rather than on a statistical collection of antenna couplers, these limit lines 709 may be set very close to the original baseline performance 710, for example within plus or minus approximately 1 dB or less of the original baseline performance 710, such as within plus or minus approximately ½ dB or less of the original baseline performance 710. It will be appreciated that, because the original baseline performance 710 of the individual antenna coupler is known, it is possible to set the pre-specified limit lines 709 within any desired distance from the original baseline performance 710, taking into consideration practical considerations. For example, the limit lines 709 should clearly be a non-zero distance (in dB) away from the original baseline performance 710, and indeed should be sufficiently far away from the original baseline performance 710 that antenna couplers are not rejected for minor variations in performance that are considered tolerable by an end user. On the other hand, the limit lines 709 may be set close enough to the original baseline performance 710 to permit immediate detection of degradations that are considered to be sufficiently large to require attention by an end user. The pre-specified limit lines 709 may be set to be a pre-specified exact amount away from the original baseline performance 710, for example plus or minus 1 dB or plus or minus ½ dB or some other pre-specified amount. It should also be appreciated that a coupler may be considered to have failed a test when its performance varies by more than a pre-specified amount, over any pre-specified range of frequencies. For example, the coupler may be considered to have failed the test when the variation occurs at only a single frequency within a larger range of frequencies of interest; or it may be considered to have failed only when the variation occurs over some range of frequencies within the larger range of frequencies of interest. Selected and overall ranges of frequencies may be up to several octaves in range, for example from more than one octave up to four octaves or more. General considerations on the selection of the pre-specified limit lines 709 will be appreciated by those of skill in the art, in light of embodiments according to the present invention. In accordance with an embodiment of the invention, an antenna coupler has the ability to store information on the antenna coupler itself, such as radio frequency test output data unique to each individual antenna coupler. Performance and other information may be uploaded to the coupler during production testing of the antenna coupler, and during subsequent testing or retuning of the antenna coupler. The antenna coupler includes a radio frequency signature storage component, which may, for example, be a two-dimensional matrix barcode, a non-volatile memory such as a non-volatile random-access memory (RAM) or read-only memory (ROM), a radio-frequency identification (RFID) component, a memory card or other computer-readable medium, or another storage component. In order to upload data from the storage component a variety of different possible techniques may be used, for example using a barcode scanner, transferring data over a data cable such as a USB cable, using an RFID transceiver, or via other techniques appropriate to the nature of the storage component. The uploaded radio frequency data may be used to test an individual antenna coupler.

An embodiment according to the invention creates accept/reject criteria that eliminate the wide tolerance of current limit line creation techniques, and allows for much more precise testing of electronic warfare systems. Further, additional information such as logistics information can be stored on the antenna coupler. For example, suggested retuning/re-characterization time frame, history of repairs and retuning, history of test results, date of testing, aircraft type, degradation in the radio frequency system of the aircraft, serial number of radar warnings and jammers used, and other logistics information can be stored on the antenna coupler.

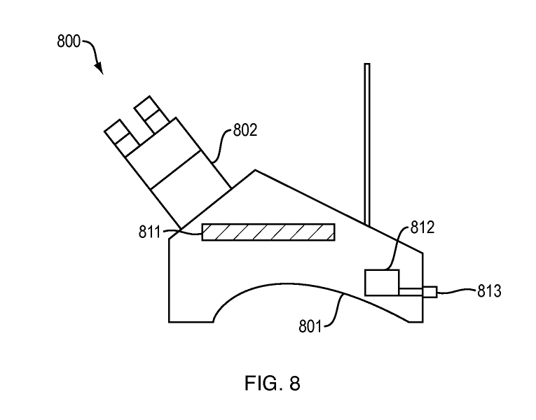

FIG. 8 is a diagram of an antenna coupler in accordance with an embodiment of the invention. The antenna coupler 800 includes a mechanical interface 801, which is used to secure the antenna coupler 800 to an antenna site of the aircraft during use of the antenna coupler 800, and a probe 802, which provides a radio-frequency output from the antenna coupler 800 over the frequency range of the antenna site of the aircraft. The antenna coupler 800 may include radio frequency absorbing material 811, which is configured to absorb radio frequency energy emitted from the electronic countermeasures system of the aircraft. In addition, the antenna coupler 800 includes a radio frequency storage component 812 that stores a representation of a radio frequency signature of the antenna coupler 800, such as radio frequency test output. For example, the radio frequency test output may include baseline confidence test output unique to the antenna coupler. The radio frequency storage component 812 may include a computer-readable medium, for example a non-volatile memory, such as non-volatile random access memory (RAM) or read-only memory (ROM); and/or may include a two-dimensional barcode or a radio-frequency identification (RFID) component. The antenna coupler 800 may include an electronic port 813 which is configured to permit electronic transfer of the stored representation of the radio frequency signature from the antenna coupler.

In accordance with an embodiment of the invention, a confidence test may be performed on the antenna coupler, either during production testing of the antenna coupler or during subsequent testing or retuning of the antenna coupler. A test wand arrangement similar to that of FIG. 1 may be used, modified to use an antenna coupler according to the invention rather than a conventional antenna coupler. In particular, to perform the confidence test in accordance with an embodiment of the invention, the radio frequency signature of the antenna coupler 800 is uploaded from the radio frequency signature storage component 812 to the test set (see 103 of FIG. 1). The radio frequency signature includes baseline confidence test output unique to the antenna coupler 800. A test input is then emitted through the test probe (see 102 of FIG. 1), thereby inducing test output to be detected by the test wand (see 104 of FIG. 1). The radio frequency output from the radio frequency test wand is then compared with the radio frequency signature that was uploaded from the storage component 812 on the antenna coupler 800, in order to assess performance of the antenna coupler 800 relative to the baseline confidence test output that is unique to the antenna coupler 800. The antenna coupler 800 is rejected if its performance varies by more than a pre-specified amount from the baseline confidence test output, for example by more than plus or minus 1 dB or more than plus or minus ½ dB from the baseline confidence test output, in a similar fashion to that discussed above in connection with the embodiment of FIG. 7.

In another embodiment according to the invention, the antenna coupler 800 may be used to test the electronic countermeasures system of an aircraft. In a similar fashion to the confidence test, a radio frequency signature is uploaded to a test set from the radio frequency signature storage component 812 of the antenna coupler. In this case, the radio frequency signature includes radio frequency test output such as a desired radio frequency output for the aircraft, which may be radio frequency output unique to the aircraft or even radio frequency output unique to the antenna site of the aircraft. A radio frequency test input is then emitted through a probe of the antenna coupler (see 102 of FIG. 1) to the antenna site of the aircraft, thereby inducing the production of radio frequency test output to be detected by the antenna coupler. For example, the aircraft may begin an electronic warfare technique, emitting radio frequency output through its transmitters. The radio frequency test output detected by the antenna coupler is then compared with the radio frequency signature that was stored in the storage component 812 of the antenna coupler, in order to assess performance of the electronic countermeasures system of the aircraft. The electronic countermeasures system performance may be rejected if it varies by more than a pre-specified amount from the radio frequency output unique to the aircraft, such as by plus or minus 1 dB or less or more than plus or minus ½ dB from a desired radio frequency output, in a similar fashion to that discussed above in connection with the embodiment of FIG. 7.

In accordance with an embodiment of the invention, during testing of an electronic countermeasures system of an aircraft, data may be downloaded from an electronic port of the aircraft to the radio frequency signature storage component 812 of the antenna coupler 800. For example, data may be downloaded from the avionics data bus port of the aircraft, such as a MIL-STD-1553 or MIL-STD-1773 port of the aircraft. Such data may then be used by the test set in evaluating performance of the aircraft electronic countermeasures system, or in other subsequent analysis. Any data downloaded through such an avionics data bus port could be suitably encrypted.

In another embodiment according to the invention, a method is used to store the test data for the antenna coupler 800 in the antenna coupler itself. Radio frequency test input is emitted through a radio frequency test probe (see 102 of FIG. 1) to the antenna coupler, thereby inducing radio frequency test output to be detected by a radio frequency test wand (see 104 of FIG. 1) coupled to the antenna coupler. A radio frequency signature comprising the radio frequency test output detected by the radio frequency test wand is then stored in the radio frequency signature storage component 812 of the antenna coupler. Such storage may be performed during production testing of the antenna coupler and/or during testing of the antenna coupler subsequent to deployment of the antenna coupler. The storing may be by any of the techniques described elsewhere herein, and may include storing logistics output data unique to the antenna coupler, as described elsewhere herein. It will be appreciated that a memory used for the radio frequency storage component 812 may be generally read-only, except when data such as history of repairs is being loaded into it, at which time the memory will permit writing of data into the memory.

Similarly, in another embodiment according to the invention, a method is used to store the test data for an electronic countermeasures system of an aircraft in the antenna coupler 800 itself. Radio frequency test input is emitted through a probe (see 102 of FIG. 1) to an antenna site of the aircraft, thereby inducing the production of radio frequency test output to be detected by the antenna coupler. A radio frequency signature comprising the radio frequency test output detected by the antenna coupler is then stored in a radio frequency signature storage component 812 of the antenna coupler 800, in a similar fashion to that used for the confidence test data storage technique described above.

Portions of the above-described embodiments of the present invention can be implemented using one or more computer systems, for example to permit automated implementation of test routines. For example, the embodiments may be implemented using hardware, software or a combination thereof. When implemented in software, the software code can be executed on any suitable processor or collection of processors, whether provided in a single computer or distributed among multiple computers.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, at least a portion of the invention may be embodied as a computer readable medium (or multiple computer readable media) (e.g., a computer memory, one or more floppy discs, compact discs, optical discs, magnetic tapes, flash memories, circuit configurations in Field Programmable Gate Arrays or other semiconductor devices, or other tangible computer storage medium) encoded with one or more programs that, when executed on one or more computers or other processors, perform methods that implement the various embodiments of the invention discussed above. The computer readable medium or media can be transportable, such that the program or programs stored thereon can be loaded onto one or more different computers or other processors to implement various aspects of the present invention as discussed above.

In this respect, it should be appreciated that one implementation of the above-described embodiments comprises at least one computer-readable medium encoded with a computer program (e.g., a plurality of instructions), which, when executed on a processor, performs some or all of the above-discussed functions of these embodiments. As used herein, the term “computer-readable medium” encompasses only a computer-readable medium that can be considered to be a machine or a manufacture (i.e., article of manufacture). A computer-readable medium may be, for example, a tangible medium on which computer-readable information may be encoded or stored, a storage medium on which computer-readable information may be encoded or stored, and/or a non-transitory medium on which computer-readable information may be encoded or stored. Other non-exhaustive examples of computer-readable media include a computer memory (e.g., a ROM, a RAM, a flash memory, or other type of computer memory), a magnetic disc or tape, an optical disc, and/or other types of computer-readable media that can be considered to be a machine or a manufacture.

The terms “program” or “software” are used herein in a generic sense to refer to any type of computer code or set of computer-executable instructions that can be employed to program a computer or other processor to implement various aspects of the present invention as discussed above. Additionally, it should be appreciated that according to one aspect of this embodiment, one or more computer programs that when executed perform methods of the present invention need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

The teachings of all patents, published applications and references cited herein are incorporated by reference in their entirety.

While this invention has been particularly shown and described with references to example embodiments thereof, it will be understood by those skilled in the art that various changes in form and details may be made therein without departing from the scope of the invention encompassed by the appended claims.

1. An antenna coupler for providing a radio frequency interface between a radio frequency electronic system of a unit under test and automatic test equipment for the radio frequency electronic system, the antenna coupler comprising:
a mechanical interface to secure the antenna coupler to an antenna site of the unit under test; and
a radio frequency signature storage component comprising a stored representation of a radio frequency signature comprising radio frequency test output.

2. An antenna coupler according to claim 1, further comprising radio frequency absorbing material configured to absorb radio frequency energy and reduce undesirable spurious radio frequency energy emitted from the radio frequency electronic system of the unit under test.

3. An antenna coupler according to claim 2, further comprising an antenna probe configured to emit radio frequency energy over a frequency range of the antenna site of the unit under test.

4. An antenna coupler according to claim 1, wherein the radio frequency test output comprises baseline confidence test output unique to the antenna coupler.

5. An antenna coupler according to claim 1, wherein the radio frequency signature storage component comprises a computer-readable medium.

6. An antenna coupler according to claim 5, wherein the computer-readable medium comprises non-volatile memory comprising at least one of: a non-volatile random access memory (RAM) and a read-only memory (ROM).

7. An antenna coupler according to claim 1, wherein the radio frequency signature storage component comprises a two-dimensional barcode.

8. An antenna coupler according to claim 1, wherein the radio frequency signature storage component comprises a radio-frequency identification (RFID) component.

9. An antenna coupler according to claim 1, further comprising an electronic port configured to permit electronic transfer of the stored representation of the radio frequency signature from the antenna coupler.

10. An antenna coupler according to claim 1, wherein the stored representation of the radio frequency signature further comprises logistics output data unique to the antenna coupler.

11. An antenna coupler according to claim 10, wherein the logistics output data comprises history of at least one of repairs and retuning of the antenna coupler.

12. An antenna coupler according to claim 10, wherein the logistics output data comprises suggested time-frame for at least one of retuning and re-characterizing the antenna coupler.

13. An antenna coupler according to claim 10, wherein the logistics output data comprises history of radio frequency test outputs unique to the antenna coupler.

14. An antenna coupler according to claim 10, wherein the logistics output data comprises at least one of: date of testing, unit under test type, degradation of a radio frequency system of the unit under test, serial number of a radar warning used by the unit under test, and serial number of a jammer used by the unit under test.

15. An antenna coupler according to claim 1, wherein the radio frequency test output comprises desired radio frequency output for the unit under test.

16. An antenna coupler according to claim 1, wherein the radio frequency test output comprises radio frequency output unique to the unit under test.

17. An antenna coupler according to claim 16, wherein the radio frequency output unique to the unit under test comprises radio frequency output unique to the antenna site of the unit under test.

18. An antenna coupler according to claim 1, further comprising a port configured to download output from an electronic port of the unit under test to the radio frequency signature storage component of the antenna coupler.

19. An antenna coupler according to claim 18, wherein the electronic port of the unit under test comprises an avionics data bus port of the unit under test.

20. An antenna coupler according to claim 1, wherein the unit under test comprises at least one of: an aircraft, a pod, a drone, a surface ship, an underwater ship and a ground platform; and wherein the unit under test comprises at least one radio frequency electronic system.

21.-90. (canceled)
